(19) United States
(12) Patent Application Publication
(10) Pub. No.: US 2026/0167264 A1
(43) Pub. Date: Jun. 18, 2026

(54) METHOD FOR ACTUATING A REAR WHEEL STEERING

(71) Applicant: Schaeffler Technologies AG & Co. KG, Herzogenaurach (DE)

(72) Inventors: Manuel Stieber, Nürnberg (DE); Lisa Marie Matuschka, Nürnberg (DE)

(73) Assignee: Schaeffler Technologies AG & Co. KG, Herzogenaurach (DE)

(21) Appl. No.: 18/707,880

(22) PCT Filed: Sep. 16, 2022
(86) PCT No.: PCT/DE2022/100692

§ 371 Date: May 6, 2024

(30) Foreign Application Priority Data
Nov. 11, 2021 (DE) 10 2021 129 318.9

(51) Int. Cl. B62D 7/15; B62D 5/04

(52) U.S. Cl. CPC B62D 7/159; B62D 5/0451; B62D 5/046; B62D 7/1581

(57) ABSTRACT

The disclosure relates to a method for actuating an actuator of a rear wheel steering of a motor vehicle. An electric motor actuates a push rod via a transmission, which converts a rotation of a rotor of the electric motor into a translation of the push rod arranged longitudinally along its travel path between two axial end positions, each of which is preceded by a deceleration section in which a travel speed of the push rod is reduced. A rotor position sensor is provided that detects a rotational position of the rotor and its rotor revolutions. Starting from an initial position of the push rod, the two end positions are each assigned a number of revolutions of the rotor on the end position side. The speed of the push rod is decelerated after a number of rotor revolutions associated with an entry of the push rod into the deceleration section.

This application is the U.S. National Phase of PCT Application No. PCT/DE2022/100692 filed on Sep. 16, 2022, which claims priority to DE 10 2021 129 318.9 filed on Nov. 11, 2021, the entire disclosures of which are incorporated by reference herein.

### TECHNICAL FIELD

The present disclosure relates to a method for actuating a rear wheel steering system of a motor vehicle.

### BACKGROUND

DE 102015211152 B4 discloses a method for actuating a rear wheel steering system of a motor vehicle. A rear wheel steering actuator comprises an electric motor that actuates a push rod via a transmission that converts a rotation of a rotor of the electric motor into a translation of the push rod. The push rod is arranged longitudinally displaceably along its travel path between two axial end positions. Both end positions are preceded by a deceleration section in which the travel speed of the push rod is reduced. A linear displacement sensor detects the position of the push rod. When the linear displacement sensor enters the deceleration section, a control device reduces the current supply.

Such linear displacement sensors in rear wheel steering systems are used to determine the position of the push rod with high precision in the region of the neutral position, in which both wheels of the rear axle are set in the direction of straight-line travel. The longer the travel path of the linear displacement sensor, the greater the measurement inaccuracy, which can lead to the push rod being displaced beyond the end position to be approached upon actuation of an end position.

### SUMMARY

The object of the present disclosure is to provide a method that enables a highly precise movement to an end position of the push rod.

This object was achieved by the method described herein.

The method for actuating a rear wheel steering system of a motor vehicle comprises an actuator, the electric motor of which actuates a push rod via a transmission that converts a rotation of a rotor of the electric motor into a translation of the push rod. For example, ball screw drives or roller screw drives, in particular planetary roller screw drives, are suitable. Trapezoidal screw drives can also be used.

In this case, the push rod can have a spindle section with an engagement profile which is wound helically around the spindle axis. A rotationally driven nut of the transmission can engage in the engagement profile directly or via planetary rollers, rollers or balls. With a true-pitch planetary roller screw drive, a full revolution of the nut corresponds to a linear displacement of the push rod by the magnitude of the pitch of the helically wound engagement profile.

The push rod is arranged longitudinally displaceably along its travel path between two axial end positions. Both end positions are preceded by a deceleration section in which the travel speed of the push rod is reduced.

The actuator is provided with a rotor position sensor, which detects a rotational position of a rotor of the electric motor and its rotor revolutions. A displacement of the push rod by a desired travel path along the push rod axis can be expressed as a number of rotor revolutions via the gear ratio of the transmission-for example composed of the gear ratio between the rotor-side drive wheel and the output wheel of the rotary transmission and the thread pitch of the screw drive.

Starting from an initial position of the push rod, a certain number of revolutions of the rotor can be associated with its two end positions. An initial position can be at any position between the two end positions. Ideally, the initial position can be the neutral position in which the push rod assumes a central position, in which the two articulated wheels are set for straight-line travel. For example, a controller configured at the vehicle level makes it possible for the actuator to be initialized when the engine of the motor vehicle starts and for the actual position of the push rod to represent the initial position as an absolute value. If necessary, the engine can be started to move to the neutral position, which then forms the initial position.

The rotor position sensor detects the rotational position of the rotor within one revolution thereof such that not only integer revolutions can be specified for the required travel path, but also fractions of a revolution.

The end positions of the push rod are defined; they result from the requirements of the automobile manufacturer. From a safety perspective, so-called overstroke of the stroke rod is minimized and ideally reduced to zero. Before the push rod reaches an end position, it passes through a deceleration section. When the push rod passes through this region, its stroke speed is decelerated. For this purpose, the current supply to the motor can be reduced accordingly and terminated when the end position is reached, such that the push rod can move flawlessly to its end position. The length of the deceleration section is adapted to the technically possible deceleration to a standstill.

The beginning and end of the deceleration sections can be stored as switching values in a control unit. When the push rod is moved, the rotor position sensor transmits the number of captured rotor revolutions and thus a travel path of the push rod that has already been covered, starting from the initial position, to the control unit. If the travel path covered shifts the push rod into the deceleration section, the travel speed can be decelerated due to the initial switching value. When the push rod reaches the end of the deceleration section-i.e. the end position-the motor is stopped via the end switching value of the deceleration section. The initial switching value and the end switching value represent the beginning and end of the deceleration section, the length of which corresponds to a known number of rotor revolutions. Starting from the actual position, it is therefore known how many rotor revolutions the rotor makes until the push rod enters the deceleration section, i.e. reaches the initial switching value, and how many rotor revolutions the rotor makes until the push rod has reached its end position, i.e. the end switching value.

An advantage of the disclosure is that the rotor position sensor of the electric motor, which is provided anyway, can be used to determine the position of the push rod. Furthermore, the measurement accuracy of the rotor position sensor is independent of the length of the travel path. Undesirable overstroke of the push rod is avoided. The linear displacement sensor known from the prior art is well suited for short measurement distances, in particular during initialization after the engine has started. However, the absolute measurement inaccuracy increases with the length of the travel path.

In an example embodiment, a linear displacement sensor is provided for detecting an absolute actual position of the push rod during initialization of the actuator. When ignition of the vehicle engine is activated, the actuator can be initialized. The linear displacement sensor, which measures highly precisely and absolutely in the region of the neutral position of the push rod, detects the actual position of the push rod, which can also be the neutral position, if necessary, after a reference run.

This actual position can be fed to a control unit, on the basis of which the maximum travel path of the push rod up to its two end positions can be determined. Starting from the transmitted actual position, any target position can then be moved to, including the end positions of the push rod, using only the rotor position sensor. The known length of the deceleration section is associated with a certain number of revolutions of the rotor, which can be determined using the known gear ratio. As a result, the entry of the push rod into the deceleration section can be determined using the rotor position sensor, and the described deceleration of the push rod can be initiated.

For safety reasons, it may be expedient to provide mechanical stops for the push rod outside the two end positions, with an overstroke section being configured between said stops and the two end positions. If the push rod exceeds its end position, an overstroke or buffer path remains before the push rod is forcibly stopped by the mechanical stop.

The travel speed of the push rod between the two deceleration sections can be constant. The electric motor can be operated with maximum torque for quick displacement. When entering the deceleration section, the torque and thus the travel speed can be decelerated linearly or non-SPECIFICATION linearly using a suitable algorithm. Upon reaching the end position, the push rod comes to a standstill. In this case, current supply to the motor can be terminated.

As already stated, a control unit can process measurement values detected by the rotor position sensor and the linear displacement sensor and control the electric motor. The method for avoiding overstroke may favorably comprise the following steps:
First, the actuator can be initialized when the engine starts and the actual position of the push rod detected by the linear displacement sensor can be transmitted to the control unit as the initial position. A target position of the push rod to be moved to is transmitted to the control unit. On the basis of the target position of the push rod and the known actual position thereof, the travel path to be covered by the push rod is calculated. This travel path is determined as a number of rotor revolutions of the electric motor, which are detected by the rotor position sensor. Current is supplied to the electric motor for a displacement of the push rod and moving to the target position.

The control unit can cause a reduction in current supply to the electric motor when the push rod enters the deceleration section. The deceleration section is only long enough that when the push rod is decelerated or braked sufficiently strongly, the rotor comes to a standstill and thus the push rod also comes to a standstill when it has reached the end position. The deceleration section has a known length corresponding to a known number of rotor revolutions. If an end position of the push rod is to be moved to as the target position, the entry of the push rod into the deceleration section can be specified and the deceleration of the push rod can be initiated using the known number of revolutions of the rotor starting from the initial position of the push rod to its end position.

### BRIEF DESCRIPTION OF THE DRAWINGS

The disclosure is explained in more detail below with reference to an exemplary embodiment shown in the two figures. In the drawings:

FIG. 1 shows a schematically illustrated actuator of a rear wheel steering system; and

FIG. 2 shows a diagram for the movement sequence of the push rod along its travel path.

### DETAILED DESCRIPTION

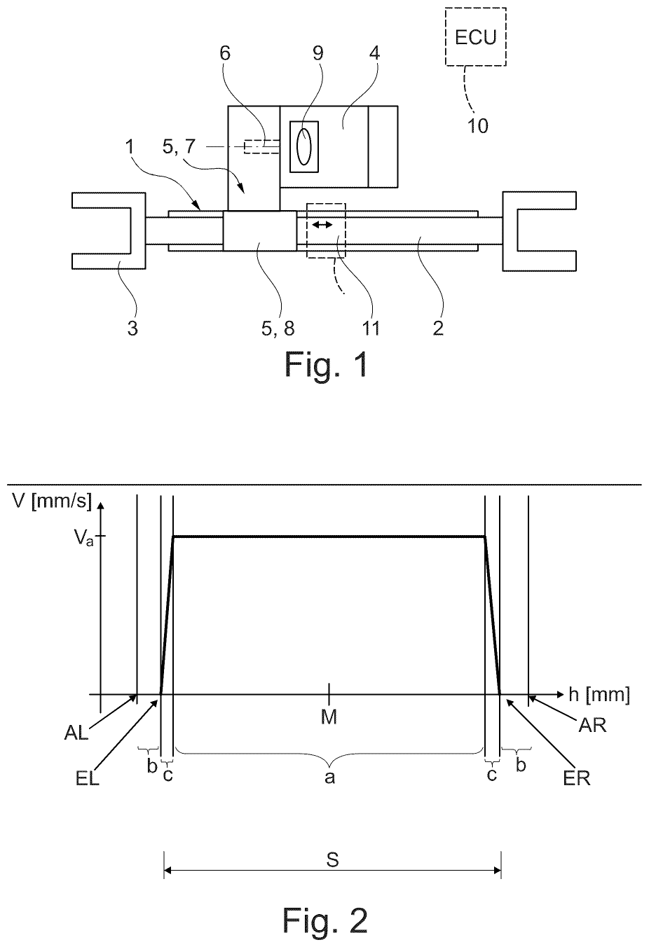

FIG. 1 shows an actuator of a rear wheel steering system, with a housing 1, a push rod 2 longitudinally displaceably mounted in the housing 1, with fork heads 3 connected to the end of the push rod 2 as part of a steering linkage for steering rear wheels (not shown) of a common axle of the motor vehicle.

An electric motor 4 drives the push rod 2 via a transmission 5. The transmission 5 is a rotation-translation transmission that converts a rotation of a rotor 6 of the electric motor 4 into a translational displacement of the push rod 2. In the exemplary embodiment, the transmission 5 comprises a known toothed belt drive 7 and a known planetary roller screw drive 8. The toothed belt drive 7 wraps with a toothed belt (not shown) around a motor pinion (not shown) of the rotor 6 and an output wheel (not shown) which is connected in a rotationally fixed manner to a drive part of the planetary roller screw drive 8. The rotation of the drive part is converted into a translational movement of the push rod 2 via a screw engagement with a spindle section of the push rod 2. With this transmission 5, a gear ratio can be specified with which the distance that the push rod covers per rotor revolution is known.

FIG. 2 shows schematically the speed of the push rod 2 along its travel path “s” between its two axial end positions “EL” on the left and “ER” on the right. Starting from a neutral position “M”, the push rod is deflected by the amount s/2. The neutral position is a center position in which the articulated wheels are aligned to drive straight ahead. The total travel path “s” is made up of a section “a”, in which the push rod 2 is displaced at an approximately constant speed Va, as well as a deceleration section “c”, which in each case precedes one of the end positions “EL”, “ER”. In the deceleration section “c”, the speed of the push rod 2 is braked, which comes to a standstill when the end position “EL”, “ER” is reached.

The actuator has a rotor position sensor 9, which detects a rotational position of the rotor 6 of the electric motor 4 and its rotor revolutions. The two end positions “EL”, “ER” of the push rod 2, starting from an initial position of the push rod 2, are associated with a number of rotor revolutions of the rotor 6 on the end position side.

In this example, the initial position is the neutral position “M”. If the push rod 2 is to move to a specific target position starting from the neutral position “M”, the travel path of the push rod 2 corresponds to a certain number of rotor revolutions, which are captured by the rotor position sensor 9.

The actuator also has a linear displacement sensor 11, which can flawlessly capture the absolute position of the push rod 2, in particular in the central region.

The signals from the linear displacement sensor 11 and the rotor position sensor are processed in a control unit 10, which is only indicated schematically in FIG. 1 and which controls the electric motor 4 and causes it to be supplied with current.

If the target position of the push rod 2 to be moved to is, for example, to one of the two end positions EL, ER, the push rod 2 first passes through the deceleration section “c” starting from its initial position/actual position. The entry of the push rod 2 into the deceleration section “c” can be mapped in the control unit 10 via the known gear ratio as the number of rotor revolutions starting from the initial position or the actual position of the push rod. The deceleration of the speed of the push rod 2 described above is initiated when it enters the deceleration section “c” until it comes to a standstill.

The number of rotor revolutions on the end position side, starting from the initial position or actual position, can be determined via the gear ratio of the transmission 5. The travel path is within the deceleration section “c” and also corresponds to a known number of rotor revolutions. As a result, the entry of the push rod 2 into the deceleration section “c” starting from the neutral position is also known. When the push rod 2 reaches the end position, the speed of the push rod 2 is reduced to a standstill.

Undesirable overstroke of the push rod 2 is fundamentally avoided, but can occur in an overstroke section “b”, into which the push rod 2 enters outside the end position “EL”, “ER”. For safety, a form-locking stop can be configured to limit the maximum possible overstroke “b” of the push rod in a form-locking manner. In the exemplary embodiment, there is an interlocking stop in the stop positions “AL” and “AR”. The distance between the end position and the stop position is set as small as possible and is subject to safety aspects and vehicle manufacturer specifications.

### LIST OF REFERENCE SYMBOLS

1 Housing
2 Push rod
3 Fork head
4 Electric motor
5 Transmission
6 Rotor
7 Toothed belt drive
8 Planetary roller screw drive
9 Rotor position sensor
10 Control unit
11 Linear displacement sensor

1. A method for actuating an actuator of a rear wheel steering system of a motor vehicle, the method comprising:
providing an actuator having:
an electric motor adapted to actuate a push rod via a transmission configured to convert a rotation of a rotor of the electric motor into a translation of the push rod arranged longitudinally displaceably along a travel path defined between two axial end positions, each of the two axial end positions preceded by a deceleration section, in which a travel speed of the push rod is reduced, and
a rotor position configured to detect to detect a rotational position and a number of revolutions of the rotor of the electric motor, and
moving the push rod from a neutral position via the electric motor towards one of two axial end positions, each of the two axial end positions corresponding to a number of revolutions of the rotor, and
decelearating a speed of the push rod after a defined number of rotor revolutions from the neutral position associated with an entry of the push rod into the deceleration section arranged ad to the one of two axial end positions.

2. The method according to claim 1, wherein the actuator further comprises a linear displacement sensor configured for detecting an absolute position of the push rod during an initialization of the actuator, and a target position of the push rod is reached according to a target number of rotor revolutions detected by the rotor position sensor starting from the neutral position of the push rod.

3. The method according to one of claim 2, in which the travel path of the push rod extends between two overstroke sections of the push rod adjacently to the two axial end positions.

4. The method according to one of claim 3, wherein a travel speed of the push rod reaches a standstill upon reaching one of the axial end positions.

5. The method according to claim 4, wherein which a control unit processes measurement values detected by the rotor position sensor and the linear displacement sensor and controls the electric motor.

6. The method according to claim 5, further comprising:
before moving the push rod from the neutral position, initialing the actuator and forwarding position of the push rod detected by the linear displacement sensor to the control unit, and
transmitting a target position of the push rod to the control unit calculation of the travel path of the push rod as a number of rotor revolutions of the rotor of the electric motor configured to be detected by the rotor position sensor.

7. The method according to claim 6, wherein the control unit causes a reduction in a current supply to the electric motor when the push rod enters the deceleration section and terminates the current supply to the electric motor when the push rod reaches the one of the two axial end positions.

8. The method according to claim 6, wherein initializing the actuator occurs when ignition of the motor vehicle is activated.

9. The method according to claim 3, wherein each of the two overstroke sections includes a mechanical stop.

10. A travel path for a push rod of a rear wheel steering system, comprising:
a constant speed section,
a first deceleration section arranged at a first end of the constant speed section, and a second deceleration section arranged at a second end of the constant speed section, and
a first overstroke section arranged adjacently to the first deceleration section such that the first deceleration section is disposed between the first overstroke section and the first end of the constant speed section, and
a second overstroke section arranged adjacently to the second deceleration section such that the second deceleration section is disposed between the second overstroke section and the second end of the constant speed section.

11. The travel path according to claim 10, wherein a first end of the first deceleration section defines a first axial end position of the push rod and a second end of the second deceleration section defines a second axial end position of the push rod.

12. The travel path according to claim 11, further comprising a first mechanical stop arranged at an end of the first overstroke section, and a second mechanical stop arranged at an end of the second overstroke section.

13. A method for actuating a steering system of a vehicle, comprising:
providing an actuator having:
an electric motor with a rotor position sensor,
a transmission configured to convert rotary motion of the electric motor to translational motion of a push rod so as to steer the vehicle, and
a control unit, and
initializing an actuator and forwarding a position of a push rod detected by a linear displacement sensor to the control unit,
transmitting a target position of the push rod to the control unit and calculating a travel path of the push rod as a number of rotor revolutions of the rotor of the electric motor configured to be controlled via the rotor position sensor and the control unit,
linearly displacing a push rod to an end position via the rotor position sensor, the push rod passing through an end of a central section of the travel path and a deceleration section of the travel path before achieving the end position.

14. The method according to claim 13, wherein travel path further comprises an overstroke section arranged adjacently to the deceleration section.

15. The method according to claim 14, wherein a mechanical stop is arranged at an end of the overstroke section.

16. The method according to claim 15, wherein the push rod travels at a constant speed through the end of the central section and decelerates to a lower speed within the deceleration section.

17. The method according to claim 13, wherein the transmission further comprises a toothed belt drive.

18. The method according to claim 17, wherein the transmission further comprises a planetary roller screw drive.

19. The method according to claim 18, wherein each end of the push rod includes a fork head.
